(19) United States
(12) Patent Application Publication
(10) Pub. No.: US 2005/0252053 A1
(43) Pub. Date: Nov. 17, 2005

(54) Display assembly for attachment to a vehicle

(76) Inventor: John Pena, West Covina, CA (US)

Correspondence Address: CHRISTIE, PARKER & HALE, LLP, PO BOX 7068, PASADENA, CA, 91109-7068, US

(21) Appl. No.: 10/845,879

(22) Filed: May 14, 2004

(51) Int. Cl. G09F 21/04

(52) U.S. Cl. 40/591

(57) ABSTRACT

A display assembly for attachment to a vehicle is provided that includes a panel assembly for receiving a display; a mounting arm removably extending from the panel assembly; and a strap assembly having a connector portion connected to the mounting arm and a strap portion for removable engagement with a rail of a roof rack that is mounted on the vehicle.

### FIELD OF THE INVENTION

The present invention relates generally to a display assembly and particularly to a display assembly for removable attachment to a vehicle.

### BACKGROUND OF THE INVENTION

Traditional advertisement display assemblies for vehicles typically include support frames that are fixedly mounted to a vehicle. These support frames support advertisement displays that are mounted thereon. These traditional advertisement display assemblies are typically bulky and consequently can cause damage to the body of the vehicle and/or require permanent alteration of the vehicle in order to allow the assembly to be mounted thereto. In addition, removing an existing advertisement display from the support frame and replacing it with a new advertisement display is often a time consuming process.

Accordingly, a need exists for a display assembly for removable attachment to a vehicle. A need also exists for a display assembly that allows for a quick and simple, removable attachment to a vehicle and/or a display assembly that allows for a quick and simple replacement of a display.

### SUMMARY

In one embodiment, the present invention is a display assembly for attachment to a vehicle that includes a panel assembly for receiving a display; a mounting arm removably extending from the panel assembly; and a strap assembly having a connector portion connected to the mounting arm and a strap portion for removable engagement with a roof rack that is mounted on the vehicle.

In another embodiment, the present invention is a display assembly for attachment to a vehicle that includes a panel assembly for receiving a display and comprising at least one socket; a mounting arm having a first end that engages a selected one of the at least one sockets and a mounting portion that defines a plurality of mounting openings; and a strap assembly having a connector portion that engages a selected one of the plurality of mounting openings and a strap portion for removable engagement with a roof rack that is mounted on the vehicle.

In yet another embodiment, the present invention is a display assembly for attachment to a vehicle that includes a panel assembly for receiving a display. The panel assembly includes a first panel and a second panel attached to the first panel such that a gap is disposed therebetween for receiving a display. A door is movably attached to either the first or the second panel between a closed position wherein the gap is enclosed such that the display is secured within the panel assembly, and an open position wherein the gap is exposed and the display can be removed from the panel assembly. The panel assembly also includes at least one socket attached to the second panel, and at least one bumper bracket attached to the second panel. The display assembly also includes a mounting arm comprising a first end that engages a selected one of the at least one sockets and a mounting portion that defines a plurality of mounting openings. A strap assembly includes a connector portion that engages a selected one of the plurality of mounting openings. The strap assembly also includes a strap portion for removable engagement with a roof rack that is mounted on the vehicle. A bumper engages a selected one of the at least one bumper brackets. The bumper includes a non-abrasive end for contacting a body of the vehicle.

In still yet another embodiment, the present invention is a display assembly for attachment to a vehicle that includes a panel assembly for receiving a display; a first strap assembly having a mounting end connected to the panel assembly and a connecting end; and a second strap assembly having a mounting end connected to the panel assembly and a connecting end. In use, the first and second strap assemblies removably wrap around a vehicle component, such as a trunk or a tailgate and form an interlocking connection between the connecting end of the first strap assembly and the connecting end of the second strap assembly.

In another embodiment, the present invention is a display assembly for attachment to a vehicle that includes a panel assembly for receiving a display; and a strap assembly removably connected to the panel assembly and including a strap portion removably connected with a roof rack that is mounted on the vehicle.

### BRIEF DESCRIPTION OF THE DRAWINGS

Novel features and advantages of the present invention will be better understood by reference to the following detailed description when considered in conjunction with the accompanying drawings wherein:

FIG. 1A is a perspective partially exploded view of a display assembly according to one embodiment of the present invention;

FIG. 1B is a perspective view of a card holder attached to a panel assembly of the display assembly of FIG. 1A;

FIG. 2A is a lateral cross-sectional view of a panel assembly of the display assembly taken from line 2-2 of FIG. 1A;

FIG. 2B is a perspective view of a mounting cord for use with the display assembly of FIG. 1A;

FIG. 2C is a perspective view of another mounting cord for use with the display assembly of FIG. 1A;

FIG. 3A is an exploded longitudinal cross-sectional view of a bumper of the display assembly of FIG. 1A, taken from line 3-3 of FIG. 1A;

FIG. 3B is a perspective view of another bumper for use with the display assembly of FIG. 1A;

FIG. 3C is a perspective view of a wheel well strap for use with the display assembly of FIG. 1A;

FIG. 4 is a perspective view of a strap assembly and a mounting arm, each for attachment to the display assembly of FIG. 1A, and also showing a locking device for attachment to the strap assembly;

FIG. 5 is an assembled longitudinal cross-sectional view of the interrelationships between the strap assembly, the mounting arm and the locking device of FIG. 4, taken from line 5-5 of FIG. 4;

FIG. 6 is an assembled perspective view of one embodiment of the display assembly according to the present invention;

FIG. 7 shows one embodiment of the display assembly according to the present invention attached to a roof rack of a vehicle; and

FIG. 8 is a perspective partially exploded view of a display assembly according to another embodiment of the present invention.

### DETAILED DESCRIPTION OF THE INVENTION

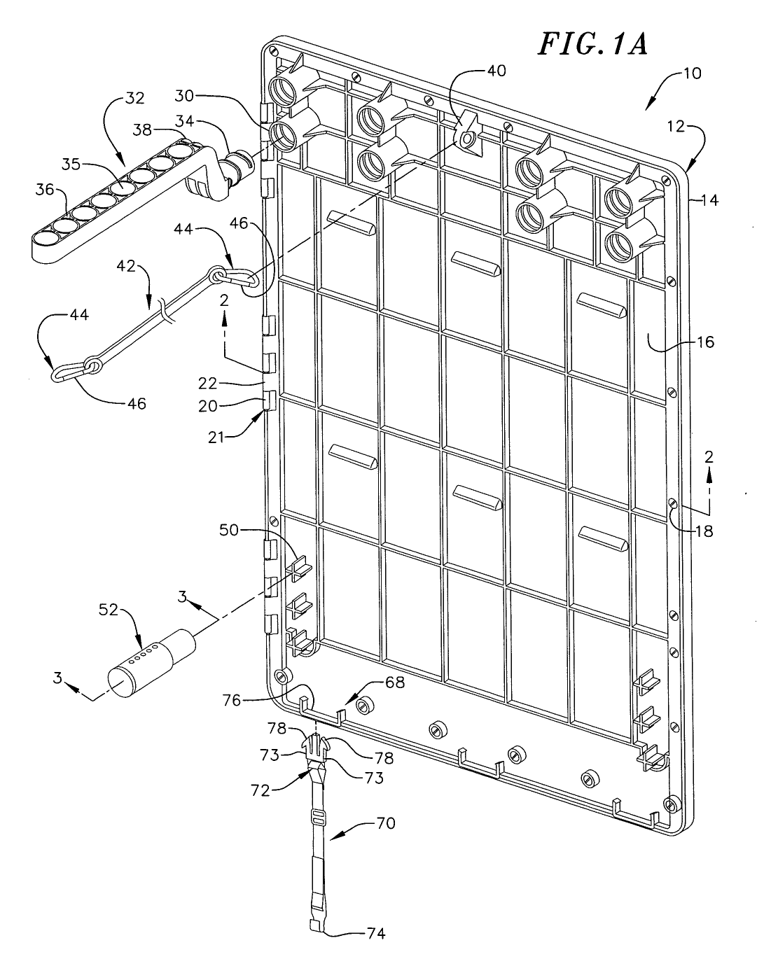

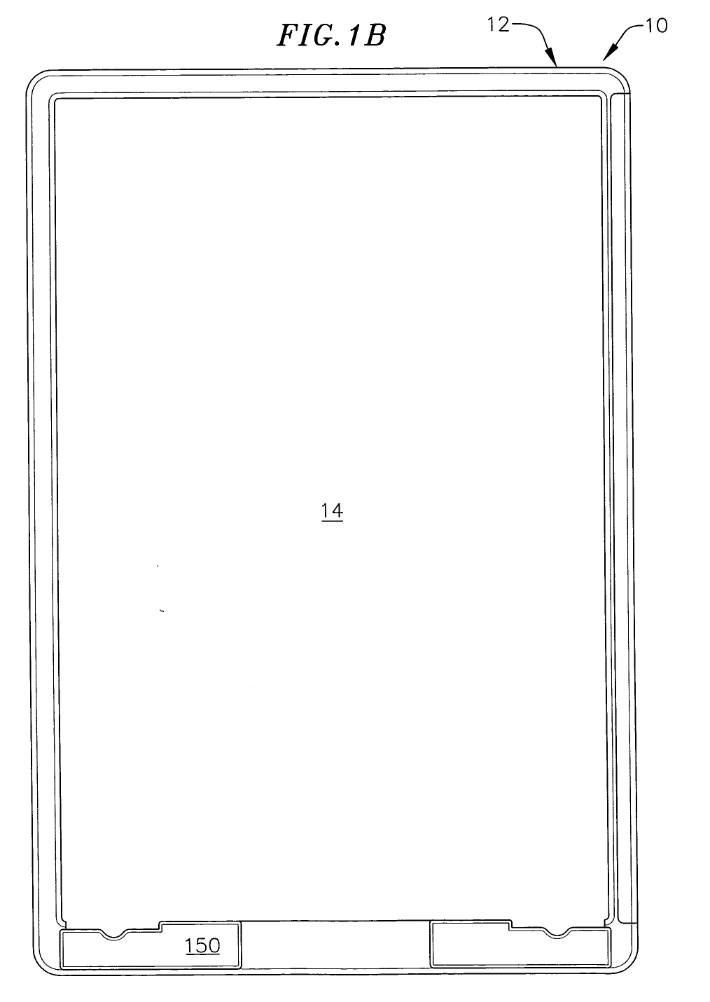

As shown in FIGS. 1-8, the present invention is directed to a display assembly. In one embodiment, an advertisement display assembly is for attachment to a vehicle, such as a sports utility vehicle (SUV) among other appropriate vehicles, having a rack mounted on its roof. In such an embodiment, the advertisement display assembly removably attaches to the roof rack of the vehicle. In another embodiment, the advertisement display assembly removably attaches to another vehicle component, such as a tailgate or a trunk

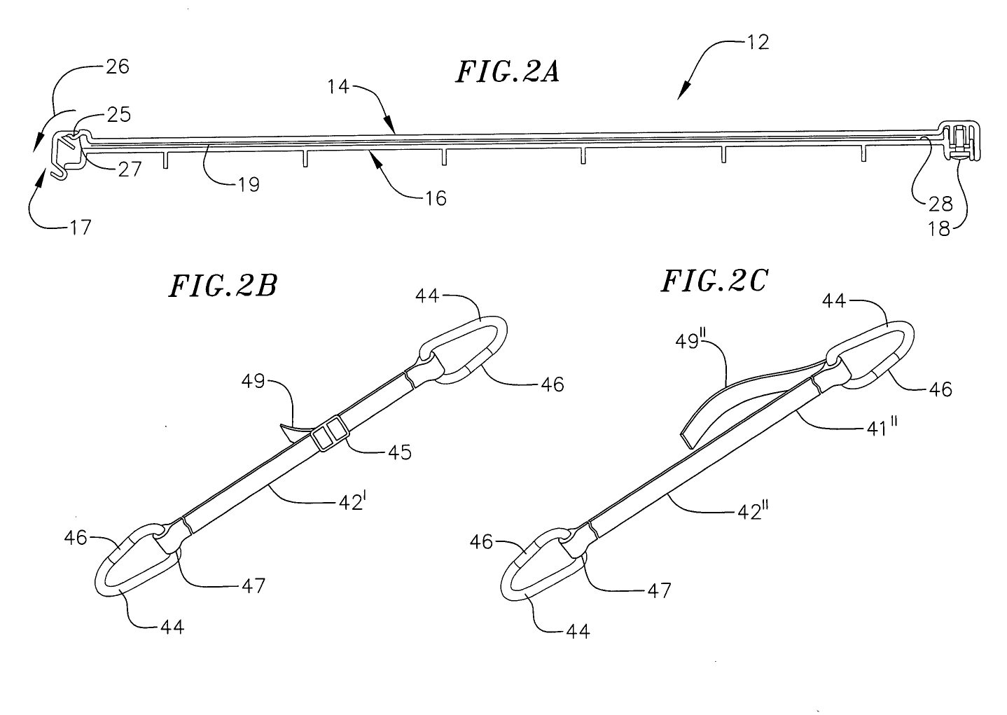

FIG. 1A shows one embodiment of the advertisement display assembly 10. The advertisement display assembly 10 includes a panel assembly 12. In the embodiment of FIG. 2A, the panel assembly 12 includes a front panel 14, a back panel 16, and a door 17. The panel assembly 12 removably receives an advertisement display 19 or another type of display such as a photograph or artistic work. In the depicted embodiment, the advertisement display 19, for example a card, a poster, a paper or another suitable material containing an advertisement, is disposed between the front panel 14 and the back panel 16.

In one embodiment, the front panel 14, the back panel 16 and the door 17 are each composed of a molded plastic material, which is transparent. Although in other embodiments other materials may be used. In one embodiment, at least the front panel 16 is composed of a transparent material so that the advertisement display 19 can be seen therethrough. The back panel 16 is secured to the front panel 14, such as by mechanical fasteners 18. When the back panel 16 is secured to the front panel 14, a gap 28 exists therebetween for receiving the advertisement display 19.

In the depicted embodiment, the door 17 is hingedly mounted to the back panel 16. Viewing FIGS. 1A and 2A together, the door 17 includes at least one mounting flange 20 and the back panel 16 includes at least one mounting flange 22. Each mounting flange 20 and 22 defines an opening that receives a pin 24. The pin 24 and the mounting flanges 20 and 22 together form a hinge 21. Alternatively, an external hinge may be used to hingedly connect the door to the back panel 16.

The hinge 21 allows for rotation of the door 17 between a closed position as shown in FIG. 2A and an open position (not shown.) When the door 17 is rotated about the hinge pin 24 from the closed position to the open position, as shown by arrow 26, the gap 28 between the front panel 14 and the back panel 16 is exposed. In such a position, the advertisement display 19 can be easily removed by reaching into the gap 28 and pulling the advertisement display 19 away from the panel assembly 12. In one embodiment, the front panel 14 is composed of non-rigid material so that the gap 28 between the front panel 14 and the back panel 16 can be slightly widened to facilitate removal of the advertisement display 19. A new advertisement display (not shown) can then be inserted into the gap 28 and secured to the panel assembly 12 by moving the door 17 from the open position to the closed position.

Such a movement of the door 17 from the open position to the closed position is accomplished by rotating the door 17 about the hinge pin 24 in the opposite direction from that shown by arrow 26. The door 17 is then lockingly engaged with the front panel 14 to secure the door 17 thereto, as well as to prevent inadvertent removal of the advertisement display 19. In the depicted embodiment, the door 17 includes a finger 25 that lockingly engages a groove 27 in the front panel 14 to secure the door 17 to the front panel 14. Although the above description describes an embodiment where the front panel 14, the back panel 16 and the door 17 are separate parts, in other embodiments, any combination or each of: the front panel 14, the back panel 16 and the door 17 may be integrally formed, such as by an injection molding process.

In the embodiment of FIG. 1B, the front panel 14 includes a card holder 150. In various embodiments, the card holder 150 is sized to receive business cards, pamphlets, flyers or other appropriate types and sizes of cards, papers or other printed materials. In addition, the front panel 14 may include more than one card holder 150 having similar or different sizes.

Referring now to FIG. 1A, the back panel 16 includes a plurality of threaded sockets 30. In the depicted embodiment, the back panel 16 includes two rows of threaded sockets 30 spaced about a longitudinal dimension of the back panel 16, with each row having four threaded sockets 30 spaced about the lateral dimension of the back panel 16. Although in other embodiments, any number and/or arrangement of threaded sockets 30 may be used. Each threaded socket 30 is adapted to mate with a mounting arm 32. The mounting arm 32 includes a threaded end 34 that threadingly engages a selected one of the plurality of threaded sockets 30 to removably secure the mounting arm 32 to the panel assembly 12. The mounting arm 32 also defines a plurality of openings 35, the significance of which is described below.

In one embodiment, the mounting arm 32 includes the threaded end 34, which is generally cylindrical, and a generally rectangular opposite end 36 having a generally flat bottom surface. The ends 34 and 36 of the mounting arm 32 are connected by a bend section 38 that adds structural stability to the mounting arm 32. The threaded end 34 of the mounting arm 32 threadably engages the threads of a selected one of the plurality of sockets 30. The flat bottom of the opposite end 36 of the mounting arm 32 contacts a roof rack when the mounting arm 32 is mounted thereto. In one embodiment, the mounting arm 32 is composed of a molded plastic material. Although in other embodiments, other materials may be used.

The number of sockets 30 allows a user a variety of mounting options for positioning the mounting arm 32 relative to the panel assembly 12. This in turn, gives the user a variety of options for selecting a desired positioning of the advertisement display assembly 10 relative to the vehicle to which the advertisement display assembly 10 is mounted. It also allows the user to vary the load imparted on the mounting arm 32 by the panel assembly 12 when the mounting arm 32, having the panel assembly 12 connected thereto, is attached to a vehicle.

The back panel 16 also includes a mounting flange 40 that defines an eyelet for receiving a mounting strap or cord 42. The mounting cord 42 includes a clamp 44 at each of its ends. Each clamp 44 has a latch 46 that is moveable between an open position and a closed position. A selected clamp 44 may be mounted to the mounting flange 40 of the panel assembly 12 by moving the latch 46 to the open position and placing a remaining portion of the clamp 44 within the eyelet of the mounting flange 40. The clamp 44 can then be moved to the closed position to secure the clamp 44 and hence the mounting cord 42 to the mounting flange 40. Preferably, the latch 46 is biased towards the closed position.

When the selected clamp 44 is attached to the mounting flange 40 of the back panel 16, the clamp 44 on the opposite side of the cord may be similarly attached to a roof rack of a vehicle as described above for the attachment of the clamp 44 to the mounting flange 40. In one embodiment, the mounting cord 42 is composed of an elastic material that allows for expansion of the mounting cord 42. For example, the mounting cord 42 may be composed of an expandable material, such as a rubber material or an elastic rope cord, such as a bungee cord.

In other embodiments, a length of the mounting cord is adjustable. For example, in the embodiment of FIG. 2B, the mounting cord 42′ includes the clamps 44 and latches 46 as described above; and a buckle mechanism 45 for adjusting a length of the mounting cord 42′. In this embodiment, the mounting cord 42′ may be composed of a material with minimal elastic properties. As shown, the mounting cord 42′ has a first end 47 attached to one of the clamps 44 and a second end 49 that is treaded a first time through the buckle mechanism 45, around the other clamp 44 and threaded a second time through the buckle mechanism 45. A desired length of the mounting cord 42′ may be obtained by varying the amount of the second end 49 of the mounting cord 42′ that is threaded through the buckle mechanism 45 for a second time.

In the embodiment of FIG. 2C, the mounting cord 42″ has the same components as that described for the mounting cord 42′ of FIG. 2B, except instead of having the buckle mechanism 45, a length of the mounting cord 42″ is adjustable due to a loop and hook connection, such as a Velcro connection, of the second end 49″ of the mounting cord 42″ to a corresponding Velcro portion 41″ of the mounting cord 42″. That is, the second end 49″ of the mounting cord 42″ includes Velcro hooks or loops and the corresponding portion 41″, of the mounting cord 42″ includes Velcro loops or hooks that mate with the second end 49″ of the mounting cord 42″. In this embodiment, the first end 47″ of the mounting cord 42″ is attached to one of the clamps 44 and the second end 49″ of the mounting cord 42″ is wrapped around the other clamp 44 with a desired amount of the second end 49″ of the mounting cord 42″ extending therethrough and attached to the corresponding Velcro portion 41″ of the mounting cord 42″. The length of the mounting cord 42″ is varied by varying the amount of the second end 49′ of the mounting cord 42″ that forms a Velcro connection with the corresponding portion 41″ of the mounting cord 42″.

The back panel 16 also includes a plurality of bumper brackets 50 (see FIG. 1A.) In the depicted embodiment, the back panel 16 includes two columns of bumper brackets 50 spaced about a lateral dimension of the back panel 16, with each column having three bumper brackets 50 spaced about a longitudinal dimension of the back panel 16. Although in other embodiments, any number and/or arrangement of bumper brackets 50 may be used.

Each bumper bracket 50 is adapted to mate with a bumper 52. The bumper 52 includes an open end that frictionally engages a selected one of the plurality of bumper brackets 50 to removably secure the bumper 52 to the panel assembly 12. In one embodiment, each bumper bracket 50 is “+” shaped and the open end of the bumper 52 is generally circular. In such an embodiment, the open end of the bumper 52 is placed in surrounding relation to the “+” shaped bumper brackets 50 to frictionally engage the bumper brackets 50.

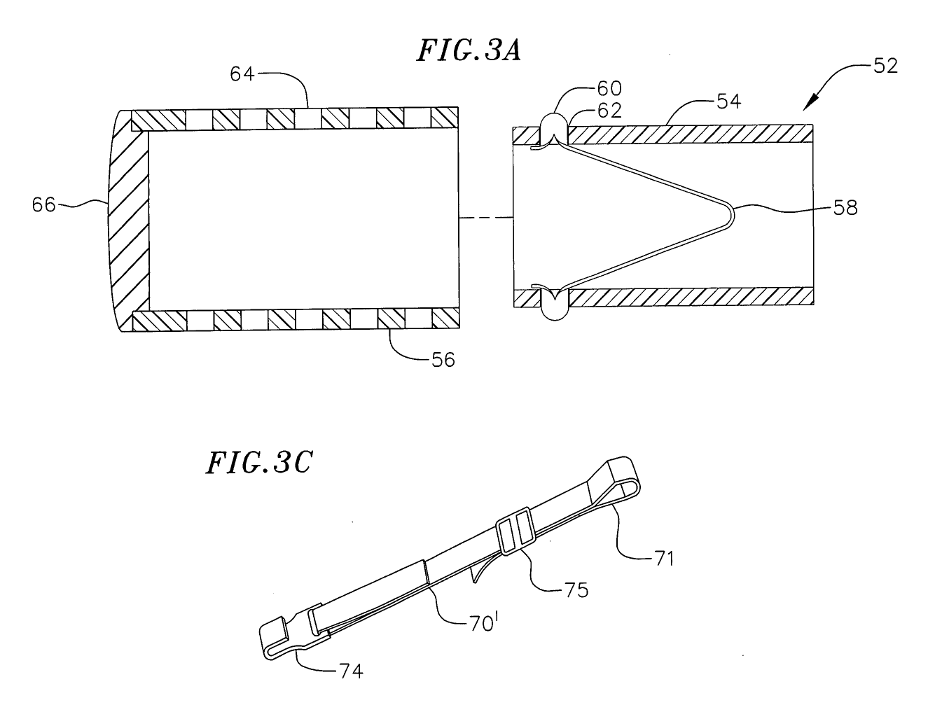

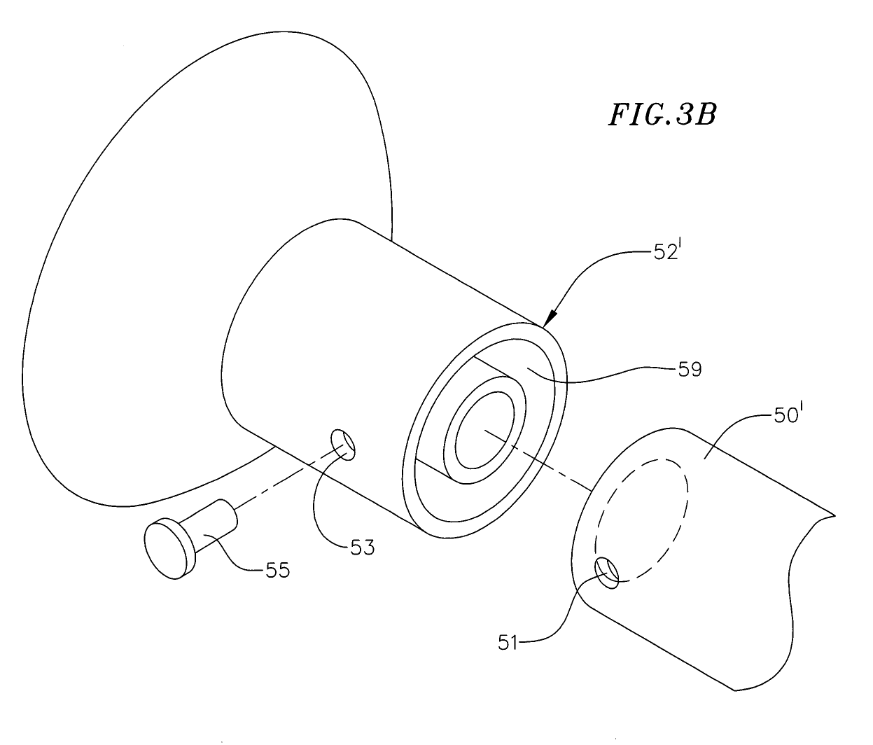

In the embodiment shown in FIG. 3A, the bumper 52 is longitudinally adjustable. As shown, the bumper 52 includes an inner tube 54 and an outer tube 56. The inner tube 54 includes a “v” shaped leaf spring 58 with ends 60 that extend through openings 62 in the inner tube 54. The outer tube 56 includes a plurality of openings 64. In one embodiment, the outer tube 56 includes two columns of openings 64 each having five openings 64 spaced about a lateral dimension of the outer tube 56, such that each opening 64 is laterally aligned with a corresponding opening 64. Although in other embodiments any number of openings 64 may be used.

The inner tube 54 is secured to the outer tube 56 by inserting the inner tuber 54 into the outer tube 56 until the ends 60 of the leaf spring 58 engage a selected pair of the openings 64 in the outer tube 56. To adjust the overall longitudinal dimension of the assembled bumper 52, the ends 60 of the leaf spring 58 are depressed to disengaged the leaf spring 58 from the openings 64 in the outer tube 56. The inner tube 54 may then be moved relative to the outer tube 56 in either a lengthening or shortening direction until the ends 60 of the leaf spring 58 engage another selected pair of the openings 64 in the outer tube 56.

A cap 66 is attached to an end of the outer tube 56 opposite from the inner tube 54. In the depicted embodiment, the cap 66 frictionally engages the outer tube 56 to secure the cap 66 to the bumper 52. In one embodiment, the inner tube 54 and the outer tube 56 are each composed of a molded plastic material. The cap 66 is composed of a non-abrasive material that is capable of contacting and pressing against a body of a vehicle, while supporting a portion of the weight of the advertisement display assembly 10, without damaging the contacted portion of the body of the vehicle. For example, in one embodiment, the cap 66 is composed of a rubber material.

In another embodiment, the cap is a suction cup. In still another embodiment, the bumper 52 itself is a suction cup. The number of bumper brackets 50 allows a user a variety of mounting options for positioning the bumper 52 relative to the panel assembly 12, and hence for positioning the bumper 52 relative to the body of the vehicle to which the advertisement display assembly 10 is attached.

In another embodiment, such as that shown in FIG. 3B, the bumper brackets 50′ are cylindrical, each having a sidewall opening 51; and the bumpers 52′ are suction cups, each having a corresponding sidewall opening 53. To mount the bumper 52′ to a desired one of the bumper brackets 50′, the bumper 52′ is placed in surrounding relation to the desired bumper brackets 50′, the sidewall openings 51 and 53 of the bumper brackets 50′ and the bumper 52 are aligned; and a pin 55 is inserted into the sidewall openings 51 and 53. In the depicted embodiment, the bumper 52′ also includes an inner wall 59 that is inserted into the desired bumper brackets 50′ when the bumper 52′ is mounted thereto. The inner wall 59 adds stability to the bumper 52′ and to the connection of the bumper 52′ to the bumper bracket 50′.

Referring back to FIG. 1A, the back panel 16 also includes a plurality of strap brackets 68. In the depicted embodiment, the back panel 16 includes a row of strap brackets 68 spaced about a lateral dimension of the back panel 16. In this embodiment, the row includes three strap brackets 68. Although in other embodiments, any number and/or arrangement of strap brackets 68 may be used. Each strap bracket 68 is adapted to mate with a wheel well strap 70. The wheel well strap 70 includes a clamp 72 on one end and a hook 74 on an opposite end.

The clamp 72 includes flexible resilient arms 73 each having outwardly extending ramps 78. Each ramp 78 allows its corresponding arm 73 to be compressed within an opening 76 in a selected one of the plurality of strap brackets 68. In the depicted embodiment, each strap bracket 68 is “U” shaped. When each ramp 78 reaches the open end of the “U” shaped bracket 68, its corresponding arm 73 resiliently springs outwardly, thus lockingly engaging the clamp 72 to the bracket 68 to secure the strap 70 to the panel assembly 12.

To disengage the strap 70 from the bracket 68, the arms 73 of the clamp 72 are pressed inwardly until each ramp 78 is within the opening 76 of the bracket 68. The strap 70 can then be pulled away from the panel assembly 12 until the arms 73 disengage the bracket 68.

In another embodiment, as shown in FIG. 3C, the wheel well strap 70′ includes a buckle mechanism 75 for adjusting a length of the wheel well strap 70′ that operates as described above for the buckle mechanism 45 of the mounting cord 42′. In this embodiment, a first end 71 of the wheel well strap 70′ is attached to a selected one of the strap brackets 68 by wrapping the first end 71 of the wheel well strap 70′ around a desired one of the strap brackets 68 and connecting it to the buckle mechanism 75; and connecting a hook 74 on the second end of the wheel well strap 70′ to the wheel well 140 of the vehicle 130.

Alternatively, the wheel well strap 70′ may contain a Velcro connection rather than the buckle mechanism 75 for adjusting the length of the of the wheel well strap 70′. In such an embodiment the Velcro connection is as described above with respect to the Velcro connections 49″ and 41″ of the mounting cord 42″. For example the strap 70′ may be utilized by wrapping a desired amount of a first end of the wheel well strap around a selected one of the strap brackets 68 and connecting its Velcro portion to a corresponding Velcro portion on the strap 70′; and connecting the hook 74 on the second end of the wheel well strap 70′ to the wheel well 140 of the vehicle 130.

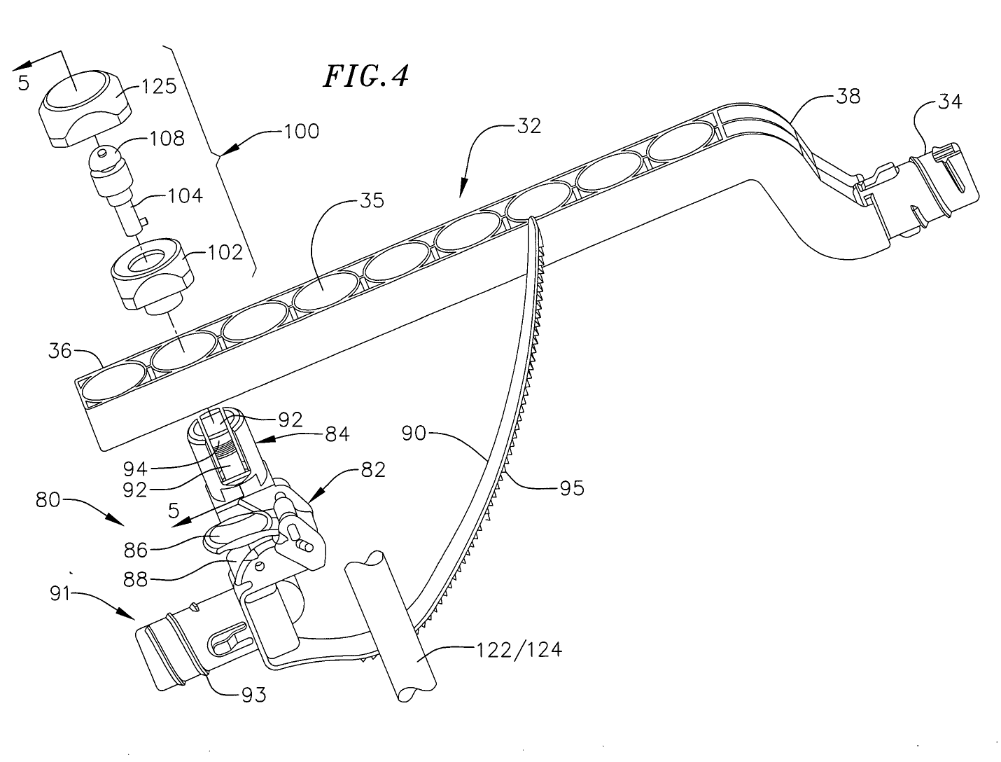

FIG. 4 shows another strap assembly 80. As described below, the strap assembly 80 is mounted to a roof rack 122/124 of a vehicle. The strap assembly 80 includes a strap portion 82 and a connector portion 84. The strap portion 82 and the connector portion 84 are integrally formed. Alternatively, the strap portion 82 may be secured to the connector portion 84, for example by mechanical fasteners. The connector portion 84 is for removably engaging a selected one of the openings 35 in the mounting arm 32, as discussed below. The strap portion 82 is for removably engaging a roof rack 122/124 of a vehicle as discussed below.

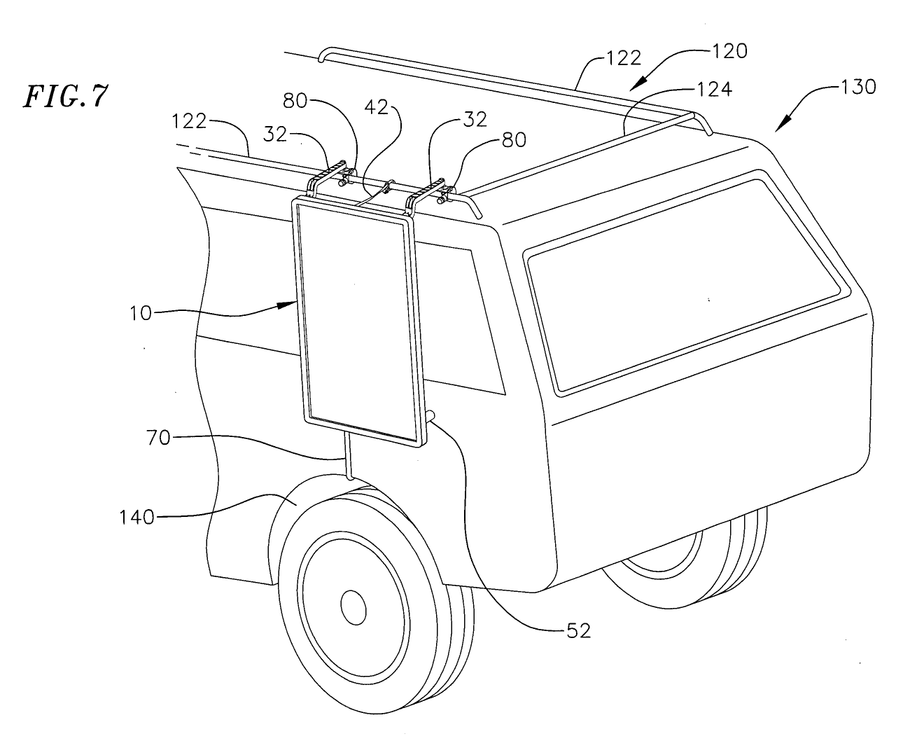

As shown in FIG. 4, the strap portion 82 includes a ratchet arm 86, a lock 88 and a strap 90. The ratchet arm 86 and the lock 88 are each pivotally mounted to the strap portion 82 by pins. In an open position (as shown in FIG. 4), the strap 90 may be wrapped around a rail 122/124 of a vehicle roof rack (see also FIG. 7.) To move the strap 90 into a closed position, the ratchet arm 86 is pivoted away from the lock 88 and the strap 90 is inserted in a space between the ratchet arm 86 and the lock 88 to form a loop. The ratchet arm 86 is then pivoted towards the lock 88 to engage the strap 90 and prevent the strap 90 from inadvertently moving to the open position. The loop of the strap 90 can be adjusted to a desired size to secure the strap 90 and hence the strap assembly 80 to a roof rack of a vehicle. Alternatively the strap 90 may contain a Velcro connection.

In one embodiment, when the strap is inserted in the space between the ratchet arm 86 and the lock 88 to form the loop, teeth 95 on the strap 90 mate with corresponding teeth in both the ratchet arm 86 and the lock 88. In a stationary position, the teeth of the ratchet arm 86 prevent the strap 90 from moving in an opening direction and the teeth of the lock 88 prevent the strap 90 from moving in a closing direction. However, the teeth of the lock 88 do not prevent the strap from moving in a closing direction.

Thus, in this embodiment, pivoting the ratchet arm 86 away from the lock 88 allows the teeth of the ratchet arm to rotate the teeth of the strap 90 to incrementally move the strap 90 in the closing direction to incrementally tighten the size of the loop of the strap 90. The loop of the strap 90 may thus be tightened to a desired size by repeatedly pivoting and releasing the ratchet arm 86.

In this embodiment, the loop of the strap 90 may be loosened by depressing the ratchet arm 86. This motion disengages both the teeth of the ratchet arm 86 and the teeth of the lock 88 from mating with the teeth of the strap 90, thus allowing the strap to be freely moved in the opening direction.

The connector portion 84 of the strap assembly 80 includes two flexible resilient arms 92 each having outwardly extending ramps 94. Each ramp 94 allows its corresponding arm 92 to be compressed within a selected one of the plurality of openings 35 in the mounting arm 32. When each ramp 94 traverses the selected opening 35 in the mounting arm 32, its corresponding arm 92 resiliently springs outwardly, thus lockingly engaging the mounting arm 32 to secure the strap assembly 80 to the mounting arm 32.

To disengage the strap assembly 80 from the mounting arm 32, the arms 92 of the connector portion 84 of the strap assembly 80 are pressed inwardly until each ramp 94 of the arms 92 of the connector portion 84 of the strap assembly 80 is within the selected opening 35 of the mounting arm 32. The arms 92 can then be pulled away from the mounting arm 32 until the arms 92 disengage the mounting arm 32.

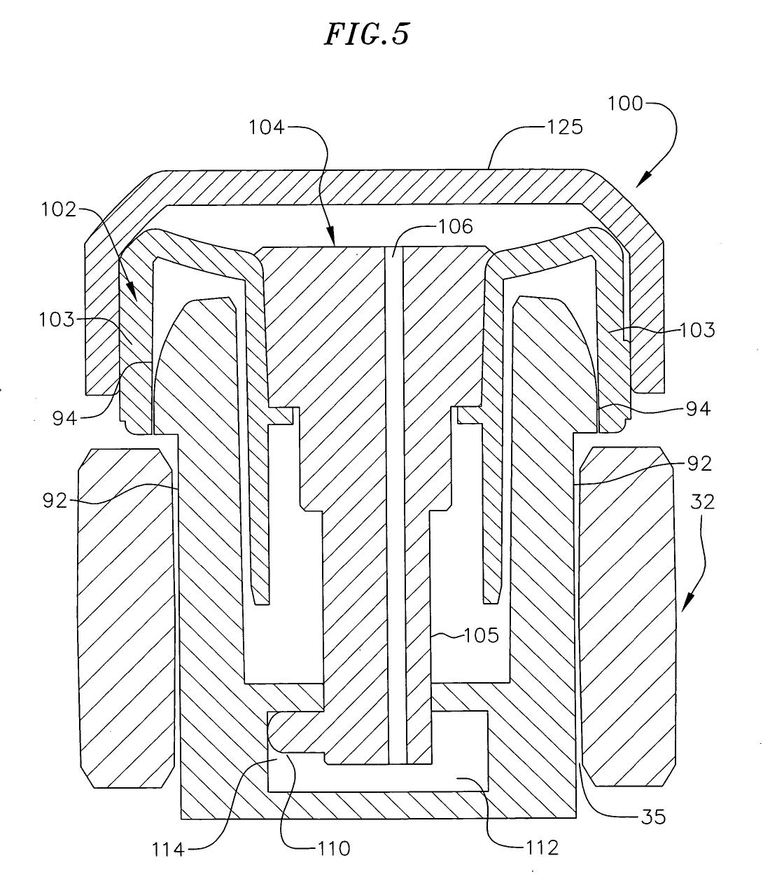

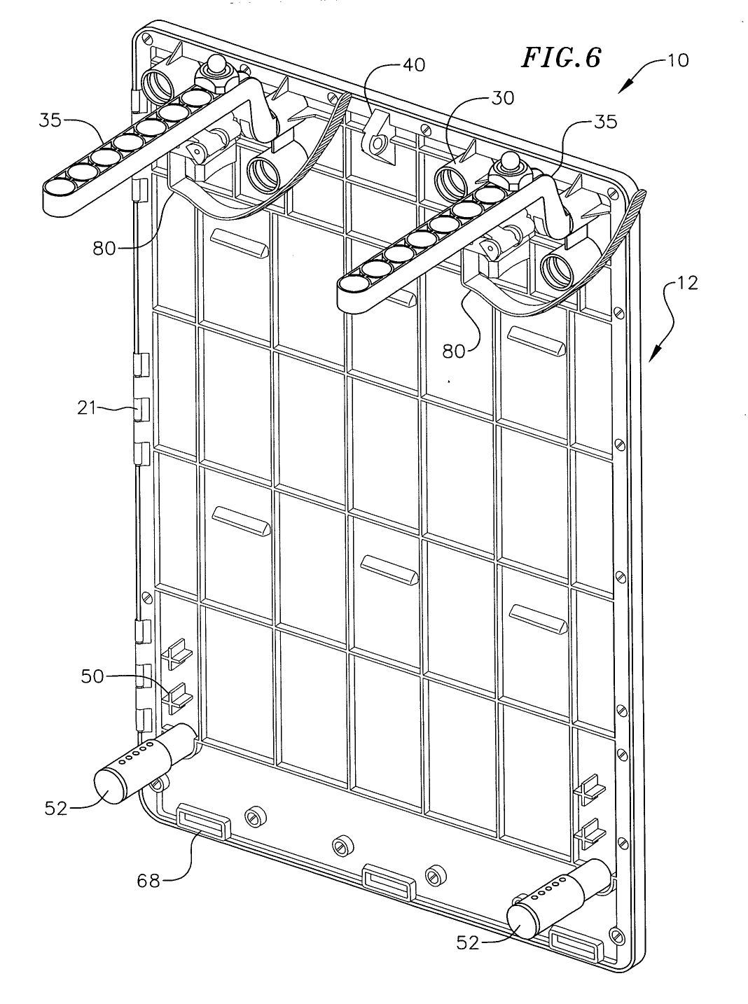

FIG. 5 shows the arms 92 of the connector portion 84 of the strap assembly 80 secured to a selected one of the plurality of openings 35 in the mounting arm 32. As shown, when the arms 92 of the strap assembly 80 are secured to the mounting arm 32, the ramps 94 of each arm 92 extend above the mounting arm 32. A locking device 100 can be secured to the connector portion 84 of the strap assembly 80 to cover the ramps 94 to prevent the ramps 94 from being inwardly depressed, and hence to prevent the strap assembly 80 from being disengaged from the mounting arm 32.

Viewing FIGS. 4 and 5 together, the locking device 100 includes a cover plate 102 having outwardly extending wings 103 and an opening for receiving a key cylinder 104. The key cylinder 104 includes a shaft 105 defining a keyway 106 for receiving a key 108. The shaft 105 also includes a protrusion 110 extending therefrom.

The locking device 100 is positioned into locking engagement with the connector portion 84 of the strap assembly 80 by inserting the locking device 100 between the arms 92 of the connector portion 84 of the strap assembly 80 until a bottom portion of the shaft 105 of the key cylinder 104 engages a groove 112 in the connector portion 84 of the strap assembly 80. When the shaft 105 is so positioned, a rotation of the key 108 causes a rotation of the shaft 105 of the key cylinder 104, which in turn causes a rotation of the protrusion 110 of the shaft 105 into blocking engagement with an extension 114 that covers a portion of the groove 112. When the locking device 100 is so positioned the locking device 100 is prevented from moving relative to the strap assembly 80, and the wings 103 of the locking device 100 cover the ramps 94 of the arms 92 of the connector portion 84 of the strap assembly 80, such that the strap assembly 80 cannot be disengaged from the mounting arm 32′. A locking device cover 125 is also provided. The cover 125 removably attaches to the cover plate 102 of the locking device 100 to protect the locking device 100 from corrosion.

As shown in FIG. 4, the strap assembly 80 also includes a mounting portion 91 that allows the strap assembly 80 to be mounted directly to the panel assembly 12, rather than indirectly through the mounting arm 32. Specifically, the mounting portion 91 of the strap assembly 80 includes threads 93 that engage a selected one of the plurality of threaded sockets 30 to removably secure the strap assembly 80 to the panel assembly 12.

FIG. 6 shows one embodiment of the advertisement display assembly 10 in an assembled condition. In this embodiment, the advertisement display assembly 10 includes two mounting arms 32, each attached to a corresponding one of the plurality of sockets 30 of the panel assembly 12. The advertisement display assembly 10 also includes two bumpers 52, each attached to a corresponding one of the plurality of bumper brackets 50.

FIG. 7 shows the advertisement display assembly 10 attached to a roof rack 120 of a vehicle 130. In the depicted embodiment, the rack 120 includes side bars 122 and a rear bar 124. However, it is to be understood that some vehicles 130 have roof racks that include one or more side bars and no rear bars, and some roof racks include one or more rear bars and no side bars.

In the depicted embodiment, the advertisement display assembly 10 is attached to a side bar 122 of the rack 120. The advertisement display assembly 10 is attached to the rack by wrapping the strap 90 of the strap portion 82 of the strap assembly 80 around the side bar 122 and adjusting the loops of the strap 90, as described above, until the strap 90 and therefore the strap assembly 80 is secured to the side bar 122.

The panel assembly 12, having a mounting arm 32 mounted thereto, as described above, can then be mounted to the side bar 122 of the rack 120 by mounting the mounting arm 32 to the strap assembly 80, as described above. Alternatively, the panel assembly 12 can be mounted directly the strap assembly in embodiments wherein the strap assembly includes the mounting portion 91 as described above. A locking device 100 can be secured to the connector portion 84 of the strap assembly 80, as described above, to prevent the mounting arm 32 from disengaging from the strap assembly 80.

When the panel assembly 12 is so attached the cap 66 of each bumper 52 or the suction cup end of each bumper 52′ contacts the body of the vehicle 130 to protect the body of the vehicle 130 from damage, such as scratching or denting. The adjusting feature of the bumper 52 also allows the length of the bumper 52 to be adjusted so that the advertisement display assembly 10 can be adjusted to hang substantially vertically from the vehicle 130. This can also be accomplished by varying the opening 35 of the mounting arm 32 in which the arms 92 of the strap assembly 80 are mounted. Varying the opening 35 of the mounting arm 32 in which the arms 92 of the strap assembly 80 are mounted and/or adjusting the length of the bumper 52 also controls how far the advertisement display assembly 10 extends from the side rail 122 of the rack 120.

Alternatively or in addition, the panel assembly 12 can be secured to the side rail 122 of the rack 120 by securing one clamp 44 of the mounting cord 42, 42′ or 42″ to the side rail 122 of the rack 120 and another clamp 44 of the mounting cord 42, 42′ or 42″ to the mounting flange 40 of the panel assembly 12. The panel assembly 12 may be secured to the rack 120 by either the mounting cord 42, 42′ or 42″ acting alone or the strap assembly 80 acting alone. However, when the panel assembly 12 is secured to the rack 120 by both the mounting cord 42, 42′ or 42″ and the strap assembly 80 a safety feature is added that prevents the panel assembly 12 from dislodging from the rack 120 even if one of the mounting cord 42, 42′ or 42″ or the strap assembly 80 fails. The panel assembly 12 can also be further secured to the vehicle 130 by attaching a first end of the wheel well strap 70 or 70′ to a selected one of the strap brackets 68 of the panel assembly 12 and securing the hook 74 of the wheel well strap 70 or 70′ to a wheel well 140 of the vehicle 130.

Although the advertisement display assembly 10 has been described above as having two mounting arm 32 mounted to the side rail 122 of the rack 120, any appropriate number of mounting arms 32 and corresponding strap assemblies 80 may be used. Similarly any appropriate number of bumpers 52 or 52′ may be used. Also although the above description describes the advertisement display assembly 10 as being attached to the side rail 122 of the rack 120, the advertisement display assembly 10 can similarly be attached to the rear rail 124 of the rack 120. In such a case, if the wheel well strap 70 or 70′ is used, the hook 74 of the wheel well strap 70 or 70′ is attached to the rear bumper of the vehicle 130 rather than to the wheel well 140 of the vehicle 130.

It is to be understood, that the advertisement display assembly 10 may be attached to any appropriate structure, such as a canopy, and is not limited to vehicles 130. In addition, one or more of the mounting arms 32 can be used as feet to support the weight of the advertisement display assembly 10 in instances where the advertisement display assembly 10 is used as a stand alone sign, supported by a ground surface. In such an embodiment, the one or more mounting arms 32 may be attached to the panel assembly 12 by threadingly engaging with selected ones of the plurality of threaded sockets 30 or an open end of the one or more mounting arms 32 may be engaged with selected ones of the bumper brackets 50 or 50′.

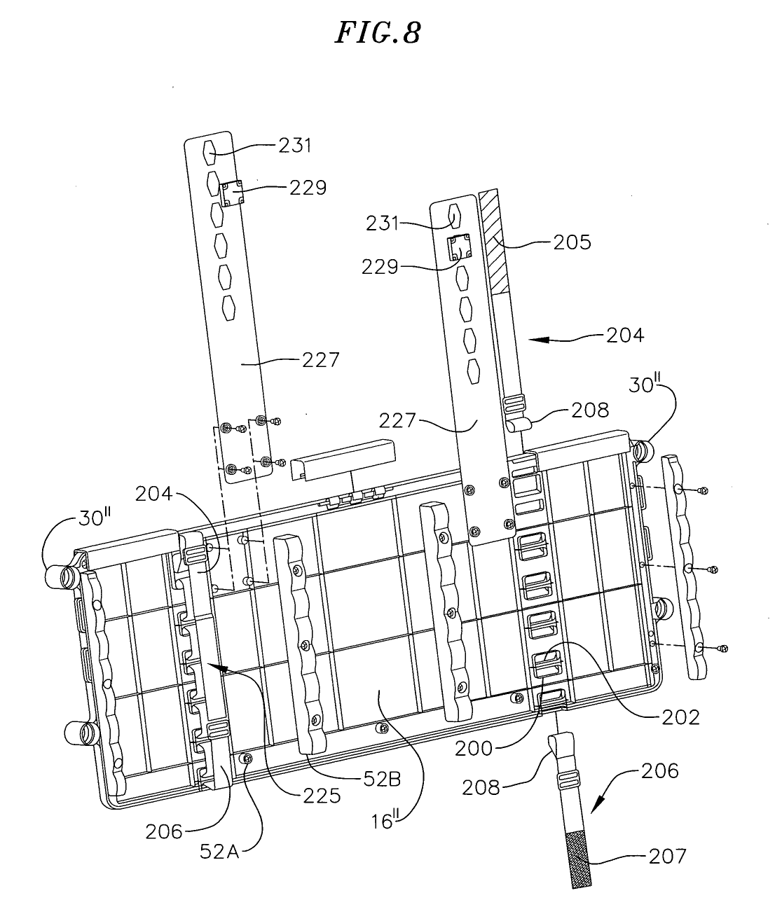

FIG. 8 shows an advertisement display assembly 10″ for attachment to a vehicle component, such as a trunk or a tailgate. The advertisement display assembly 10″ includes the panel assembly 12″ as described above, the sockets 30″ for receiving mounting arms (not shown) and the card holder (not shown.) The advertisement display assembly 10″ also includes bumpers 52A and/ or 52B attached to a back panel 16″, of the panel assembly 12″. In the depicted embodiment the back panel 16″ includes a plurality of rubber stoppers 52A and a plurality of rubber strips 52B. In other embodiments, the back panel may include one or more of any of the bumpers described above. The back panel 16″ also includes a plurality of strap brackets 200.

Each strap bracket 200 includes a finger 202 for receiving a strap assembly 225. In the depicted embodiment, each strap assembly 225 includes a first strap 204 and a second strap 206 (note that in the left side of FIG. 8 the strap assembly 225 is shown attached to the advertisement display assembly 10″ and for clarity in the right side of FIG. 8 the strap assembly 225 is shown detached from the advertisement display assembly 10″.) An end of each strap 204 and 206 has a slot for receiving a finger 202 from a corresponding one of the strap brackets 200. In addition, the first strap 204 includes a Velcro portion 205 having Velcro hooks or loops for forming an interlocking connection with a Velcro portion 207 on the second strap 206.

When it is desired to attach the advertisement display assembly 10″ to a vehicle component, the back panel 16″ is placed adjacent to an outer surface of the vehicle component, such that the bumpers 52A and/or 52B are disposed between the back panel 16″ and the vehicle component; and the straps are wrapped around the vehicle component and interlockingly connected together at Velcro portions 205 and 207. The straps 204 and 206 allow for some variance in the size of the vehicle component to which the advertisement display assembly 10″ is mounted since varying amounts of the Velcro portions 205 and 207 can be interlockingly connected. However, to allow for an even greater amount of variance in the size of the vehicle, the ends of the straps 204 and 206 may be mounted to any desired one of the strap brackets 200 allowing the distance between the Velcro portions 205 and 207 of the straps 204 and 206 to be increased or decreased as desired.

In an alternative embodiment, the straps 204 and 206 have the slotted ends 208 as described above and hooks at opposite ends thereof for connecting to the vehicle component. For example, in such an embodiment, the hook of the first strap assembly 204 is attached to an upper edge of the vehicle component and the hook of the second strap assembly 206 is attached to a lower edge of the vehicle component. The hooks may be composed of a non-abrasive material such as a plastic material to protect the vehicle component from damage, such as by denting or scratching.

The advertisement display assembly 10″ also includes at least one flexible arm 227. In the embodiment of FIG. 8, the advertisement display assembly 10″ includes two flexible arms 227, each mounted to the back panel 16″ of the advertisement display assembly 10″. Each flexible arm 227 includes a plurality of openings 231 for receiving a lock 229. To attach the advertisement display assembly 10″ to a vehicle component, such as a vehicle trunk or a vehicle tailgate by use of the flexible arms 227, a mounting device (not shown) that receives the lock 229 is mounted to the vehicle component; the flexible arms 227 are wrapped around the vehicle component; the lock 229 is inserted into a selected one of the plurality of openings 231; and the lock 229 is interlockingly connected to the mounting device of the vehicle component. Such an arrangement and method are described in detail in U.S. patent application Ser. No. 10/285,816, filed on Nov. 1, 2002; and U.S. patent application Ser. No. 10/423,106, filed on Apr. 25, 2003, each of which is incorporated herein by reference.

In any of the embodiments disclosed above, a light source may be attached, either externally or internally, to the panel assembly to facilitate seeing the advertisement display assembly 10 in dark conditions. For example, in one embodiment, the light source is attached to the back panel 16 of the panel assembly 12. Also, in any of the embodiments disclosed above, a Global Positioning Sensor (GPS) may be attached to the advertisement display assembly to track the location of the advertisement display assembly as it is transported.

The preceding description has been presented with references to presently preferred embodiments of the invention. Persons skilled in the art and technology to which this invention pertains will appreciate that alterations and changes in the described structures and methods of operation can be practiced without meaningfully departing from the principle, spirit and scope of this invention. Accordingly, the foregoing description should not be read as pertaining only to the precise structures described and shown in the accompanying drawings.

1. A display assembly for attachment to a vehicle comprising:
a panel assembly for receiving a display;
a mounting arm removably extending from the panel assembly; and
a strap assembly comprising a connector portion removably connected to the mounting arm and a strap portion removably connected with a roof rack that is mounted on the vehicle.

2. The display assembly of claim 1, wherein the panel assembly comprises at least one socket that engages the mounting arm.

3. The display assembly of claim 2, wherein the at least one socket comprises a threaded end that threadably engages a corresponding threaded end of the mounting arm.

4. The display assembly of claim 1, wherein the mounting arm comprises a mounting portion that defines a plurality of openings and wherein the connector portion of the strap assembly removably engages a selected one of the mounting arm openings to removably secure the strap assembly to the mounting arm.

5. The display assembly of claim 4, wherein the connector portion of the strap assembly comprises at least one resilient arm that removably engages the selected one of the mounting arm openings.

6. The display assembly of claim 5, wherein the at least one resilient arm comprises a first portion with a ramp and a catch and a second portion, wherein the catch secures the connector portion to the selected one of the mounting arm openings when the second portion of the arm is disposed within the selected mounting arm opening and the first portion of the arm extends from the mounting portion of the mounting arm.

7. The display assembly of claim 4, further comprising a locking device attached to the connector portion of the strap assembly to prevent the strap assembly from disengaging the mounting arm.

8. The display assembly of claim 1, wherein the strap assembly comprises a strap and a pivot arm, wherein the strap removably engages the pivot arm such that in an engaged position the strap forms a closed loop for placement in surrounding relation to a rail on the roof rack of the vehicle to secure the strap assembly to the vehicle roof rack.

9. The display assembly of claim 8, wherein the pivot arm comprises teeth that mate with corresponding teeth on the strap to incrementally move the strap when the strap is engaged with the pivot arm.

10. The display assembly of claim 1, further comprising a mounting cord having a first end that removably engages the roof rack of the vehicle, and wherein the panel assembly comprises a mounting flange that defines an eyelet that engages a second end of the mounting cord.

11. The display assembly of claim 10, wherein the first end of the mounting cord comprises a clamp that removably engages the roof rack of the vehicle, and wherein the second end of the mounting cord comprises a clamp that engages a second end of the mounting cord.

12. The display assembly of claim 1, further comprising a bumper having a non-abrasive end for contacting a body of the vehicle, and wherein the panel assembly comprises at least one bumper bracket that engages the bumper.

13. The display assembly of claim 12, wherein the non-abrasive end of the bumper comprises a suction cup.

14. The display assembly of claim 12, wherein the bumper is adjustable such that an amount of the bumper that extends from the bumper bracket is extendable.

15. The display assembly of claim 1, further comprising a wheel well strap having a first end that removably engages a wheel well of the vehicle, and wherein the panel assembly comprises at least one strap bracket that defines an opening that engages a second end of the wheel well strap.

16. The display assembly of claim 15, wherein the first end of the wheel well strap comprises a hook that removably engages the wheel well of the vehicle, and wherein the second end of the mounting cord comprises a resilient arm that engages the opening in the at least one strap bracket.

17. The display assembly of claim 1, wherein the panel assembly comprises a first panel and a second panel having a gap therebetween for receiving the display.

18. The display assembly of claim 17, wherein the panel assembly comprises a door movably connected to the second panel from a closed position wherein the gap is enclosed such that the display is secured within the panel assembly, and an open position wherein the gap is exposed and the display can be removed from the panel assembly.

19. The display assembly of claim 1, further comprising a bumper having a suction cup for removably connecting to a body of the vehicle.

20. The display assembly of claim 1, further comprising a card holder attached to the panel assembly.

21. The display assembly of claim 1, further comprising a light source attached to the panel assembly.

22. The display assembly of claim 1, further comprising a Global Positioning Sensor attached to the panel assembly.

23. A display assembly for attachment to a vehicle comprising:
a panel assembly for receiving a display and comprising at least one socket;
a mounting arm comprising a first end that removably engages a selected one of the at least one sockets and a mounting portion that defines a plurality of mounting openings; and
a strap assembly comprising a connector portion that engages a selected one of the plurality of mounting openings and a strap portion for removable engagement with a roof rack that is mounted on the vehicle.

24. The display assembly of claim 23, wherein the first end of the mounting arm comprises threads that threadably engage thread of the selected one of the at least one sockets.

25. The display assembly of claim 23, wherein the connector portion of the strap assembly comprises at least one resilient arm that removably engages the selected one of the mounting arm openings.

26. The display assembly of claim 25, wherein the at least one resilient arm comprises a first portion with a ramp and a catch and a second portion, wherein the catch secures the connector portion to the selected one of the mounting arm openings when the second portion of the arm is disposed within the selected mounting arm opening and the first portion of the arm extends from the mounting portion of the mounting arm.

27. The display assembly of claim 23, further comprising a locking device attached to the connector portion of the strap assembly to prevent the strap assembly from disengaging the mounting arm.

28. The display assembly of claim 23, wherein the strap assembly comprises a strap and a pivot arm, wherein the strap removably engages the pivot arm such that in an engaged position the strap forms a closed loop for placement in surrounding relation to a rail on the roof rack of the vehicle to secure the strap assembly to the vehicle roof rack.

29. The display assembly of claim 28, wherein the pivot arm comprises teeth that mate with corresponding teeth on the strap to incrementally move the strap when the strap is engaged with the pivot arm.

30. The display assembly of claim 23, further comprising a mounting cord having a first end that removably engages the roof rack of the vehicle, and wherein the panel assembly comprises a mounting flange that defines an eyelet that engages a second end of the mounting cord.

31. The display assembly of claim 30, wherein the first end of the mounting cord comprises a clamp that removably engages the roof rack of the vehicle, and wherein the second end of the mounting cord comprises a clamp that engages a second end of the mounting cord.

32. The display assembly of claim 23, further comprising a bumper having a non-abrasive end for contacting a body of the vehicle, and wherein the panel assembly comprises at least one bumper bracket that engages the bumper.

33. The display assembly of claim 32, wherein the bumper is adjustable such that an amount of the bumper that extends from the bumper bracket is extendable.

34. The display assembly of claim 23, further comprising a wheel well strap having a first end that removably engages a wheel well of the vehicle, and wherein the panel assembly comprises at least one strap bracket that defines an opening that engages a second end of the wheel well strap.

35. The display assembly of claim 34, wherein the first end of the wheel well strap comprises a hook that removably engages the wheel well of the vehicle, and wherein the second end of the mounting cord comprises a resilient arm that engages the opening in the at least one strap bracket.

36. The display assembly of claim 23, wherein the panel assembly comprises a first panel and a second panel having a gap therebetween for receiving the display.

37. The display assembly of claim 36, wherein the panel assembly comprises a door movably connected to the second panel from a closed position wherein the gap is enclosed such that the display is secured within the panel assembly, and an open position wherein the gap is exposed and the display can be removed from the panel assembly.

38. A display assembly for attachment to a vehicle comprising:
a panel assembly for receiving a display and comprising:
a first panel;
a second panel attached to the first panel such that a gap is disposed therebetween for receiving a display;
a door movably attached to either the first or the second panel between a closed position wherein the gap is enclosed such that the display is secured within the panel assembly, and an open position wherein the gap is exposed and the display can be removed from the panel assembly;
at least one socket attached to the second panel; and
at least one bumper bracket attached to the second panel;
a mounting arm comprising a first end that engages a selected one of the at least one sockets and a mounting portion that defines a plurality of mounting openings;
a strap assembly comprising a connector portion that engages a selected one of the plurality of mounting openings and a strap portion for removable engagement with a roof rack that is mounted on the vehicle; and
a bumper that engages a selected one of the at least one bumper brackets and having a non-abrasive end for contacting a body of the vehicle.

39. A display assembly for attachment to a vehicle comprising:
a panel assembly for receiving a display; and
a first strap assembly comprising a mounting end connected to the panel assembly and a connecting end; and
a second strap assembly comprising a mounting end connected to the panel assembly and a connecting end;
wherein the first and second strap assemblies removable wrap around a vehicle component selected from the group consisting of a trunk and a tailgate and form an interlocking connection between the connecting end of the first strap assembly and the connecting end of the second strap assembly.

40. The display assembly of claim 39, wherein the panel assembly comprises a plurality of strap brackets.

41. The display assembly of claim 40, wherein the mounting end of the first strap assembly is removably connected to a chosen one of the plurality of strap brackets; and wherein the mounting end of the second strap assembly is removably connected to a chosen one of the plurality of strap brackets; and

42. The display assembly of claim 41, wherein each of the plurality of strap brackets comprises a finger; and wherein the mounting ends of the first and second strap brackets each form a removable connection with the finger of a chosen one of the plurality of strap brackets.

43. The display assembly of claim 41, wherein each of the plurality of strap brackets comprises a finger; and wherein the mounting ends of the first and second strap brackets each comprise a slot for removably receiving the finger of a chosen one of the plurality of strap brackets.

44. The display assembly of claim 39, wherein the connecting end of the first strap assembly comprises hooks that mate with corresponding loops on the connecting end of the second strap assembly.

45. The display assembly of claim 39, wherein the connecting end of the first strap assembly comprises loops that mate with corresponding hooks on the connecting end of the second strap assembly.

46. The display assembly of claim 39, further comprising at least one bumper connected to the panel assembly.

47. The display assembly of claim 39, wherein the panel assembly comprises a first panel and a second panel having a gap therebetween for receiving the display.

48. The display assembly of claim 47, wherein the first panel is transparent.

49. The display assembly of claim 47, further comprising a cap that is pivotally connected to the panel assembly and moveable between a closed position wherein the gap is enclosed; and an open position wherein the gap is exposed.

50. A display assembly for attachment to a vehicle comprising:
a panel assembly for receiving a display; and
a strap assembly removably connected to the panel assembly and comprising a strap portion removably connected with a roof rack that is mounted on the vehicle.

51. The display assembly of claim 50, wherein the strap assembly removably extends directly from the panel assembly.

52. The display assembly of claim 50, wherein the strap assembly comprises a mounting portion and the panel assembly comprises at least one socket, and wherein the mounting portion of the strap assembly removably engages a selected one of the at least one sockets.

53. The display assembly of claim 52, wherein the at least one socket comprises a threaded end that threadably engages a corresponding threaded end of the mounting portion of the strap assembly.

54. The display assembly of claim 50, wherein the strap assembly comprises a strap and a pivot arm, wherein the strap removably engages the pivot arm such that in an engaged position the strap forms a closed loop for placement in surrounding relation to a rail of the vehicle roof rack to secure the strap assembly to the vehicle roof rack.

55. The display assembly of claim 54, wherein the pivot arm comprises teeth that mate with corresponding teeth on the strap to incrementally move the strap when the strap is engaged with the pivot arm.

56. The display assembly of claim 52, further comprising a mounting cord having a first end that removably engages a the roof rack of the vehicle, and wherein the panel assembly comprises a mounting flange that defines an eyelet that engages a second end of the mounting cord.

57. The display assembly of claim 56, wherein the first end of the mounting cord comprises a clamp that removably engages roof rack of the vehicle, and wherein the second end of the mounting cord comprises a clamp that engages a second end of the mounting cord.

58. The display assembly of claim 52, further comprising a bumper having a non-abrasive end for contacting a body of the vehicle, and wherein the panel assembly comprises at least one bumper bracket that engages the bumper.

59. The display assembly of claim 58, wherein the bumper is adjustable such that an amount of the bumper that extends from the bumper bracket is extendable.

60. The display assembly of claim 52, further comprising a wheel well strap having a first end that removably engages a wheel well of the vehicle, and wherein the panel assembly comprises at least one strap bracket that defines an opening that engages a second end of the wheel well strap.

61. The display assembly of claim 60, wherein the first end of the wheel well strap comprises a hook that removably engages the wheel well of the vehicle, and wherein the second end of the mounting cord comprises a resilient arm that engages the opening in the at least one strap bracket.
